(19) United States
(12) Patent Application Publication
(10) Pub. No.: US 2020/0317522 A1
(43) Pub. Date: Oct. 8, 2020

(54) ONE-STEP SINGLE HEATER BASED FLOW SYNTHESIS SETUP FOR SYNTHESIS OF INORGANIC PARTICLES IN NEAR AMBIENT CONDITIONS

(71) Applicant: COMSATS University Islamabad, Islamabad (PK)

(72) Inventors: Aqif Anwar CHAUDHRY, Lahore (PK); Kashif Ijaz, Lahore (PK); Hafsah Akhtar, Lahore (PK)

(21) Appl. No.: 16/425,295

(22) Filed: May 29, 2019

Related U.S. Application Data
(63) Continuation-in-part of application No. 16/373,185, filed on Apr. 2, 2019.

(51) Int. Cl. C01B 25/32; C01B 25/26

(52) U.S. Cl. CPC C01B 25/32; C01B 25/26; C01P 2002/82; C01P 2004/03; C01P 2002/72

(57) ABSTRACT

A flow synthesis system (FSS) based on contamination free PTFE tubing, a pump for pumping requisite solutions and a heater for heating precipitated flow suspensions has been designed. Synthesis, using FSS, eliminates the need for secondary heat-treatments and/or long ageing times required in traditional inorganic synthesis routes. The FSS was used successfully to synthesis calcium phosphates which include phase-pure and ion substituted hydroxyapatite, respectively. Biologically beneficial magnesium, zinc, carbonate and silicon ions were successfully incorporated into hydroxyapatite.

### CROSS-REFERENCE TO RELATED APPLICATIONS

This application is a Continuation-in-Part of U.S. patent application Ser. No. 16/373,185, filed on Apr. 2, 2019, and claims priority from and the benefit of Pakistan Patent Application No. 378/2018, filed on May 30, 2018, which are hereby incorporated by reference for all purposes as if fully set forth herein.

### BACKGROUND

### Field

Exemplary embodiments of the invention relate generally to a flow synthesis system (FSS) based on contamination free PTFE tubing, a pump for pumping requisite solutions, and a heater for heating precipitated flow suspensions for the synthesis of inorganic particles in near ambient conditions.

### Discussion of the Background

Traditional approaches for the synthesis of bioceramics depend on materials which require strict parameters control or very long synthesis periods. The majority of room temperature batch synthesis methods for bioceramics tend to be multi-step, energy intensive, or time consuming processes. For example, in wet chemical syntheses of hydroxyapatite (HA), a maturation step (>18 h), followed by a heat treatment of 650° C., is required. Although batch hydrothermal process facilitates a simpler, lower temperature based and relatively efficient way to synthesize phase pure HA however, most of the time it requires templating agents along with long reaction time (up to 24 hours).

Current continuous production of HA is carried out at temperatures in excess of the range of 200-400° C., which is energy intensive. Furthermore, at such high temperatures, although nucleation occurs, there is substantial growth or agglomeration of smaller nuclei to form substantially larger particles. Additionally, there is a disadvantage of having to use high temperature continuous systems, in that they are conducted in an all metal tubing setup—due to the high reaction temperatures. Therefore, if such a process were used to make bioceramics, they would contain substantial levels of leached metals from the steel (e.g. Fe, Cr, etc.). This would mean that the bioceramics may not be acceptable for clinical use based on unwanted metal ions present. Consequently, a need arises to develop smaller nano-sized calcium phosphates using methods, which allow for fine control over particle sizes, preferably under relatively mild conditions of temperature and pressure, and with purity acceptable for use in a clinical setting such as for bone replacement. One known method of HA production at near ambient conditions (20-60° C.) was reported in the patent literature that involves the mixing of reagents in multiple stages using a multiple step reactor with strong stirring.

Similarly, for oxides much work has been published on ZnO and ZnO doped materials' synthesis routes and applications. However, a simple and quick route that provides access to nanosized particles with tailorable properties is highly desirable. Phase pure and doped zinc oxides are generally synthesized via wet-chemical/precipitation, sol-gel methods, co-precipitation, solid-thermal methods, hydrothermal synthesis, emulsion techniques, and spray pyrolysis. Flow synthesis of ZnO is a relatively new approach. Reports in literature rely on complex and expensive flow systems which rely on high temperature and pressure. Therefore, there is a need for a simple flow methodology which facilitates a one-step, rapid route to synthesis.

Therefore, attempts have been made to develop a simple, low cost, clean, synthesis technique, which could work under mild conditions and allow the synthesis of high purity stoichiometric HA and other bioceramic materials in a considerably short time period with a fine and controllable particle size (range from 20-150 nm) and controlled surface area (typically range from 95-300 m²g⁻¹), depending on reaction conditions.

The above information disclosed in this Background section is only for understanding of the background of the inventive concepts, and, therefore, it may contain information that does not constitute prior art.

### SUMMARY

Devices constructed according to exemplary implementations and methods according to exemplary embodiments of the invention are capable of synthesis of inorganic particles in near ambient conditions.

A flow synthesis system (FSS) based on contamination free PTFE tubing, a pump for pumping requisite solutions and a heater for heating precipitated flow suspensions has been designed. This novel design is based on the need to develop calcium phosphate and oxide based nanoceramics with tailorable properties in a simple single step synthesis method. Synthesis therefore, using FSS, eliminates the need for secondary heat-treatments and/or long ageing times required in traditional inorganic synthesis routes. The FSS was used successfully to synthesis calcium phosphates which include phase-pure and ion substituted hydroxyapatite, respectively. Biologically beneficial Magnesium, Zinc, Carbonate and Silicon ions were successfully incorporated into hydroxyapatite. The versatility of FSS to synthesis calcium phosphates based on different precursors was also elucidated in this work. These nanoparticles can have great range of applications for use in replacement of hard tissues such as bone and teeth, as bone graft substitutes, injectable solutions, coatings on metallic implants, as fillers or additives in commercial products, such as toothpastes; materials for the controlled release of drugs, or other controlled release therapies; reinforcements in biomedical composites, and in bone and dental cements. The novel FSS was also used to synthesize phase-pure oxides which include ZnO and CeO₂. Doped zinc oxides were also obtained by successfully incorporation of K, Fe, Ca, Ce & Mg ions in zinc oxide whilst retaining the original phase (proven through extensive X-ray Diffraction Studies). These compositional directives influence particulate properties which include size and morphology. Promising photocatalysts, antibacterial agents (standalone or as reinforcements in polymers) and semiconductors were hence synthesized based on sizeable reduction in band gaps as a result of doping. Summarily, novel FSS developed herein is the first instance of its kind. Its use therefore to synthesize materials for bone regeneration, photo catalysis, antibacterial response and semiconducting applications is carefully elucidated.

Additional features of the inventive concepts will be set forth in the description which follows, and in part will be apparent from the description, or may be learned by practice of the inventive concepts.

In an exemplary embodiment of the invention, a system includes: a pump with three feeds; a stainless steel T-piece reactor; and a heater having tubing passing through it. The pump is connected to the T-piece reactor, the T-piece reactor is connected to the tubing passing through the heater, and the feeds and the tubing are formed of contamination free polytetrafluoroethylene (PTFE).

A first feed of the pump may send a first solution to the T-piece reactor and a second feed of the pump may send a second solution to the T-piece reactor.

The third feed of the pump may send a third solution to the T-piece reactor.

The exemplary system may be used in a method to synthesize inorganic particles, wherein the solutions from at least two feeds of the pump react in the T-piece reactor to form a reaction suspension.

The reaction suspension of the T-piece reactor may pass through the heater.

The suspension may exit from the heater and be collected in a container in a continuous manner.

The first solution and second solution may be selected for continuous flow synthesis of grafted and non-grafted inorganic nanoparticles.

The first solution and second solution may be selected for the synthesis of inorganic particles and nanoparticles.

The first solution and second solution may be selected for the synthesis of inorganic particles and nanoparticles of a single phase.

The first solution and second solution may be selected for the synthesis of inorganic particles and nanoparticles belonging to different phases.

The first solution and second solution may be selected for the synthesis of inorganic particles and nanoparticles grafted with organic groups.

The first solution and second solution may be selected for synthesis based on variable flow rates.

The pump may maintain the same flow rate in all feeds.

The reaction times may be varied based on flow rates.

The reactions times may be increased by increasing a length of the tubing in the heater.

Different solution concentrations may be used to influence reaction yield.

A pH of the feed solutions may be varied.

A pH of all feed solutions may be varied independently.

The inorganic particles may be synthesized with varying crystallinity.

The reaction temperatures may be varied.

The reaction temperatures may be varied to influence phase purity of product.

The reaction temperatures may be varied to influence crystallinity.

Grafted and non-grafted inorganic particles and nanoparticles may be synthesized in gram and kilogram level yields.

Different elements may be doped into inorganic particles and nanoparticles.

The resultant particle size may be varied.

The dopant levels into inorganic particles and nanoparticles may be varied.

The reactions may be carried out based on a water soluble reagent.

The feeds may be in the form of suspensions.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 illustrates a schematic of an exemplary embodiment of a Flow Synthesis System with a three reagent Feed pumped through a peristaltic pump (P) into a cross-piece reaction point (X) and then into a vertical heater (H1) prior to collection immediately after exit from (H1).

FIG. 2 shows X-ray Diffraction patterns of Sample A, Sample B, and respective versions heat treated at 1100° C. (denoted by HT).

FIG. 3 shows SEM images of: (a) Sample A at 1000× magnification with a 20 μm scale, (b) Sample A at 5000× magnification with a 5 μm scale (c) Sample B at 1000× magnification with a 20 μm scale, and (d) Sample B at 5000× magnification with a 5 μm scale.

FIG. 4 shows X-ray Diffraction patterns of Samples (a) A (b) B (c) C and (d) D, and an ICDD 09-432 pattern is shown in (e).

FIG. 5 shows X-ray Diffraction Patterns of (a) Sample A and (b) a reference pattern of HA (ICDD Pattern #09-432).

FIG. 6 shows SEM images of samples (a) Zn-HA at 5000× magnification with a 5 μm scale, and (b) Zn-HA at 10000× magnification with a 2 μm scale,

FIG. 7 shows X-ray Diffraction Patterns of (a) Sample B and (b) a reference pattern of HA (ICDD Pattern #09-432).

FIG. 8 shows SEM images of samples (a) Mg-HA at 5000× magnification with a 5 μm scale, and (b) Mg-HA at 10000× magnification with a 2 μm scale.

FIG. 9 shows X-ray Diffraction Patterns of (a) Sample C and (b) a reference pattern of HA (ICDD Pattern #09-432).

FIG. 10 shows SEM images of samples (a) Si-HA at 5000× magnification with a 5 μm scale, and (b) Si-HA at 10000× magnification with a 2 μm scale.

FIG. 11 shows X-ray Diffraction Patterns of (a) Sample D and (b) a reference pattern of HA (ICDD Pattern #09-432).

FIG. 12 shows SEM images of samples (a) Carbonated HA at 5000× magnification with a 2 μm scale, and (b) Carbonated HA at 10000× magnification with a 1 μm scale.

FIG. 13 shows X-ray Diffraction patterns of Samples (a) A (b) B (c) C and (d) D, and an ICDD 010-0333 pattern is shown in (e).

FIG. 14 shows electron microscopy images of (a) Sample (A) 500× magnification with a 50 μm scale, (b) Sample (B) 500× magnification with a 50 μm scale, (c) Sample (C) 500× magnification with a 50 μm scale, and (d) Sample (D) 500× magnification with a 50 μm scale.

FIG. 15 shows X-ray Diffraction Patterns of Samples (a) synthesized zinc oxide and (b) ICDD Pattern #36-1451.

FIG. 16 shows SEM images of samples (a) ZnO at 5000× magnification with a 5 μm scale, and (b) ZnO at 10000× magnification with a 2 μm scale.

FIG. 17 shows X-Ray Diffraction Patterns of (a) 0.5Ce—ZnO, (b) 1Ce—ZnO and (c) 2Ce—ZnO, (d) ZnO, and (e) ICDD Pattern #36-1451.

FIG. 18 shows X-Ray Diffraction Patterns of (a) 0.5Ca—ZnO, (b) 1Ca—ZnO, (c) 2Ca—ZnO, (d) ZnO, and (e) ICDD Pattern #36-1451.

FIG. 19 shows X-Ray Diffraction Patterns of (a) 0.5K—ZnO, (b) 1K—ZnO, (c) 2K—ZnO, (d) ZnO, and (e) ICDD Pattern #36-1451.

FIG. 20 shows X-Ray Diffraction Patterns of (a) 0.5Fe—ZnO, (b) 1Fe—ZnO, (c) 2Fe—ZnO, (d) ZnO, and (e) ICDD Pattern #36-1451.

FIG. 21 shows X-Ray Diffraction Patterns of (a) 0.5Mg—ZnO, (b) 1Mg—ZnO, (c) 2Mg—ZnO, (d) ZnO, and (e) ICDD Pattern #36-1451.

FIG. 22 shows SEM images of Ce—ZnO samples (a) 0.5 Ce—ZnO at 20000× magnification with a 2 μm scale, (b) 0.5 Ce—ZnO at 100000× magnification with a 200 nm scale, (c) 1 Ce—ZnO at a 20000× magnification with a 2 μm scale, (d) 1 Ce—ZnO at a 100000× magnification with a 200 nm, scale, (e) 2 Ce—ZnO at a 20000× magnification with a 2 μm scale, and (f) 2 Ce—ZnO at 100000× magnification with a 200 nm scale.

FIG. 23 shows SEM images of K—ZnO samples (a) 0.5 K—ZnO at 20000× magnification with a 2 μm scale, (b) 0.5 K—ZnO at 100000× magnification with a 200 nm scale, (c) 1 K—ZnO at 20000× magnification with a 2 μm scale, (d) 1 K—ZnO at 100000× magnification with a 200 nm scale, (e) 2 K—ZnO at 20000× magnification with a 2 μm scale, (f) 2 K—ZnO at 100000× magnification with a 200 nm scale.

FIG. 24 shows SEM images of Ca—ZnO samples (a) 0.5 Ca—ZnO at 20000× magnification with a 2 μm scale, (b) 0.5 Ca—ZnO at 100000× magnification with a 200 nm scale, (c) 1 Ca—ZnO at 20000× magnification with a 2 μm scale, (d) 1 Ca—ZnO at 100000× magnification with a 200 nm scale, (e) 2 Ca—ZnO at 20000× magnification with a 2 μm scale, (f) 2 Ca—ZnO at 100000× magnification with a 200 nm scale.

FIG. 25 shows SEM images of Fe—ZnO samples (a) 0.5Fe—ZnO at 20000× magnification with a 2 μm scale, (b) 0.5Fe—ZnO at 100000× magnification with a 200 nm scale, (c) 1Fe—ZnO at 20000× magnification with a 2 μm scale, (d) 1Fe—ZnO at 100000× magnification with a 200 nm scale, (e) 2Fe—ZnO at 10000× magnification with a 2 μm scale, (f) 2Fe—ZnO at 100000× magnification with a 200 nm scale.

FIG. 26 shows SEM images of Mg—ZnO samples (a) 0.5 Mg—ZnO at 20000× magnification with a 2 μm scale, (b) 0.5Mg—ZnO at 100000× magnification with a 200 nm scale, (c) 1Mg—ZnO at 20000× magnification with a 2 μm scale, (d) 1Mg—ZnO at 100000× magnification with a 200 nm scale, (e) 2Mg—ZnO at 20000× magnification with a 2 μm scale, (f) 2Mg—ZnO at 100000× magnification with a 200 nm scale.

FIG. 27 shows X-Ray Diffraction Patterns of (a) CeO2, and (b) ICDD Pattern #34-0394.

FIG. 28 shows SEM images of samples (a) CeO2 at 5000× magnification with a 5 μm scale, and (b) at 10000× magnification with a 10 μm scale.

FIG. 29 shows FTIR spectra of Pure ZnO and Grafted ZnO.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

When an element is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element, there are no intervening elements present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

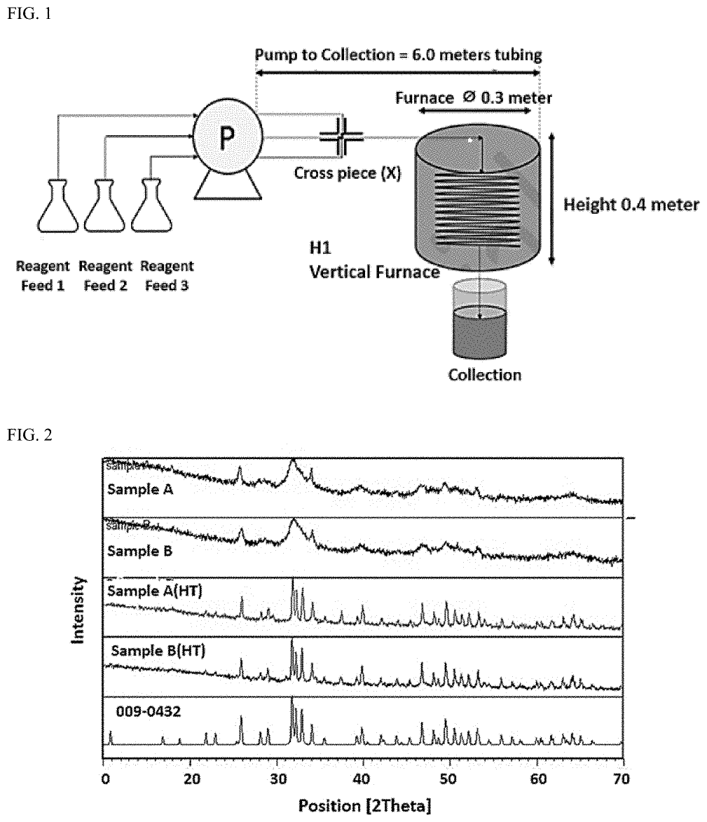

As illustrated in FIG. 1, the Flow Synthesis System consists of single peristaltic pump P with multiple inputs and outputs, connected to 6-meter-long Polytetrafluoroethylene PTFE tubing (which gives good resistance to strong pH and is easy to clean). Reagents were stored in a reservoir of required size which was connected to the pump using ¼ inch external diameter PTFE tubing. The tubing exiting from the pump was connected to a 1/16 inch stainless steel 316 L grade (SS316L) T-piece when two reagent inputs were used or to a 1/16 inch SS316L Cross(X)-piece when 3 reagent inputs were used. The T-piece and the X-piece act as reaction points in the FSS. After the mixing point, the PTFE tube was coiled inside a vertical furnace (1000 W) where length of 750 Watts programmable furnace was 0.4 meters and diameter was 0.3 meters. The total length of tubing from the pump to collection was 6.0 meters. Solutions (reagent feeds) were prepared in glass beakers, respectively, followed by continuous stirring of solutions on a magnetic stirrer plate. The precursor solutions were pumped at a specific flow rate (depend on conditions of reactions) to meet at the 1/16-inch SS316L T-piece. This initial mixture was connected to 6-meter long ¼-inch external diameter PTFE tubing which was coiled inside a vertically aligned heater. The product is collected from the end of the tube at ambient pressure. In typical reaction reagents all flow through the pump to react at the T or X piece resulting in immediate precipitation—this suspension then flows into the hot zone H1 regulated at the required temperature. The particles in the suspension react to the temperature in the hot zone and exit at an elevated temperature. Suspensions are collected in a beaker and can be oven and freeze dried to obtain nano and micro sized particles.

Calcium hydroxide solution and Diammonium hydrogen phosphate with the concentrations shown in Table 1 were pumped using a peristaltic pump at a flow rate of 30 ml/min with the exit temperature at 70° C. (controlled using adjusting set temperature of Heater H1). Resulting suspension was collected immediately after exit. The suspension was then centrifuged followed by washing (×2 times) using deionized water. Synthesized samples were then freeze dried using an Alpha 1-2 LD plus freeze dryer.

TABLE 1
Concentrations and volumes of precursors used for synthesis
of 2 samples of hydroxyapatite (A, B) in this study.

| | | Volume | | Volume |
|---|---|---|---|---|
| Reactions | Concentration | (mL) | Concentration | (mL) |
| ID | Diammonium hydrogen phosphate | | Calcium Hydroxide | |
| Sample A | 0.3M | 250 | 0.5M | 250 |
| Sample B | 0.3M | 250 | 0.3M | 250 |

X-ray Diffraction: XRD analysis confirmed samples to be phase pure hydroxyapatite when compared to ICDD Pattern #09-432 as no other peak was observed in the spectrum (please see FIG. 2).

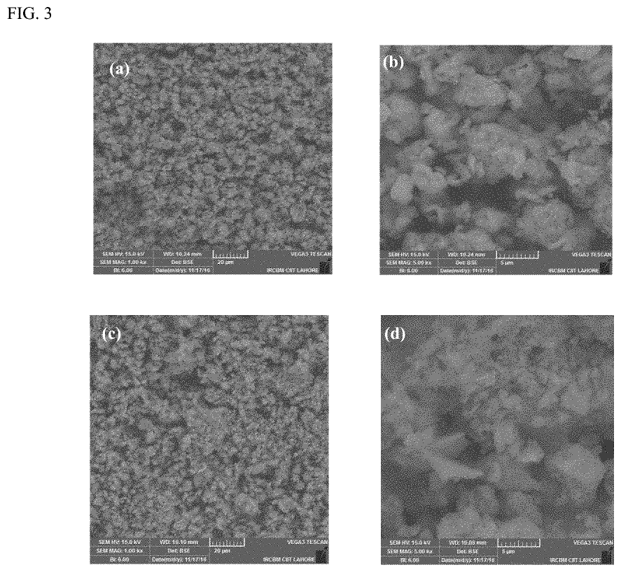

Scanning Electron Microscopy: SEM was performed to analyze morphology and particle size of the samples synthesized. The average particle size was calculated at 1000× and 5000× magnifications about 4 μm as seen in image (a) of FIG. 3. Agglomerates of particles can be seen in images (a), (b), (c), and (d) of FIG. 3.

Synthesis of Hydroxyapatite Using Calcium Nitrate Tetrahydrate & Diammonium Hydrogen Phosphate

Phase pure HA: Similarly, reactions were carried out with Diammonium hydrogen phosphate solution and Calcium nitrate tetrahydrate solution with the different concentrations as shown in Table 2 were pumped at a flow rate 30 ml/min with the exit temperature 70° C. The pH was maintained 10 with 3 ml of ammonium hydroxide solution. Then the mixture was centrifuged and filtered and washed twice by de-ionized water.

TABLE 2
Concentrations and volumes of precursors used for synthesis
of 4 samples of hydroxyapatite (A, B, C and D) in this study.

| | | Volume | | Volume |
|---|---|---|---|---|
| | Concentration | (mL) | Concentration | (mL) |
| Reactions | Diammonium | | Calcium nitrate | |
| ID | hydrogen phosphate | | tetra hydrate | |
| Sample A | 0.3M | 200 | 0.5M | 200 |
| Sample B | 0.3M | 200 | 0.6M | 200 |
| Sample C | 0.3M | 200 | 0.3M | 200 |
| Sample D | 0.3M | 200 | 0.6M | 200 |

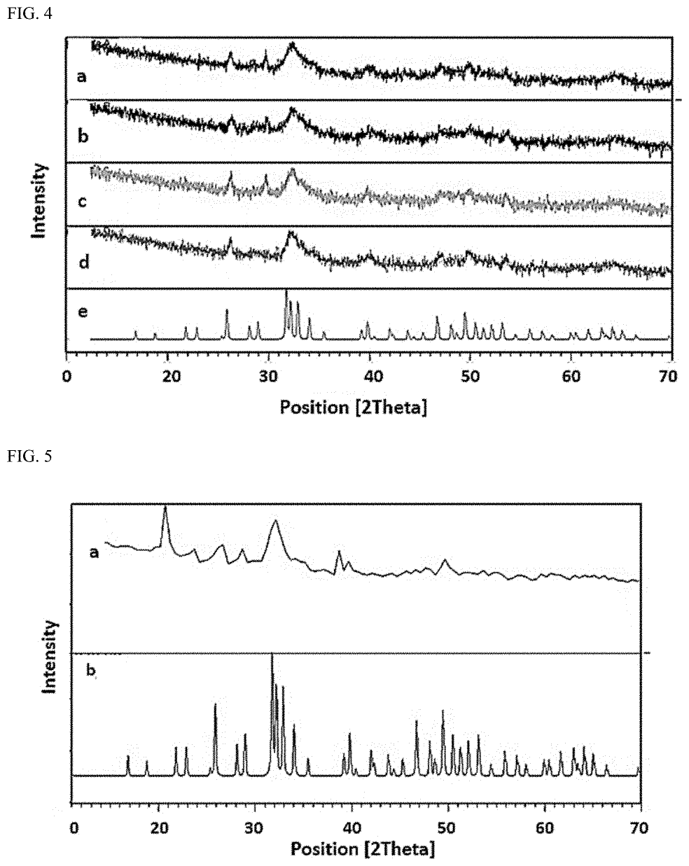

X-ray Diffraction: confirms the synthesis of Hydroxyapatite when compared to ICDD Pattern #09-432. But another peak was observed in the spectrum near 30 Theta, which was possibly due to unreacted Calcium Hydroxide, as shown in images (a)-(e) of FIG. 4.

Ion Substituted Hydroxyapatite: Substituted reactions were carried out with Diammonium hydrogen phosphate solution and Calcium nitrate tetrahydrate solution with the different concentrations as shown in Table 3 were pumped at a flow rate 30 ml/min with the exit temperature 70° C. The pH was maintained 10 with 3 ml of ammonium hydroxide solution. Then the mixture was centrifuged and filtered and washed twice by de-ionized water.

TABLE 3
Concentrations and volumes of precursors used for synthesis of 4 samples
of Substituted hydroxyapatite (A, B, C and D) in this study.

| | | | Volume | | Volume |
|---|---|---|---|---|---|
| Reactions ID | | Concentration | (mL) | Concentration | (mL) |
| Sample A | Zinc Substituted HA | 0.15M | 200 | 0.3M | 200 |
| Sample B | Magnesium substituted HA | 0.15M | 200 | 0.3M | 200 |
| Sample C | Silicone Substituted HA | 0.15M | 200 | 0.3M | 200 |
| Sample D | Carbonated HA | 0.15M | 200 | 0.3M | 200 |

Zinc Substituted Hydroxyapatite (Zn-HA)

X-ray Diffraction: It is clearly seen from XRD pattern (a) of FIG. 5 that all peaks match to those of HA (compared to ICDD Pattern #09-432), which confirms the phase purity.

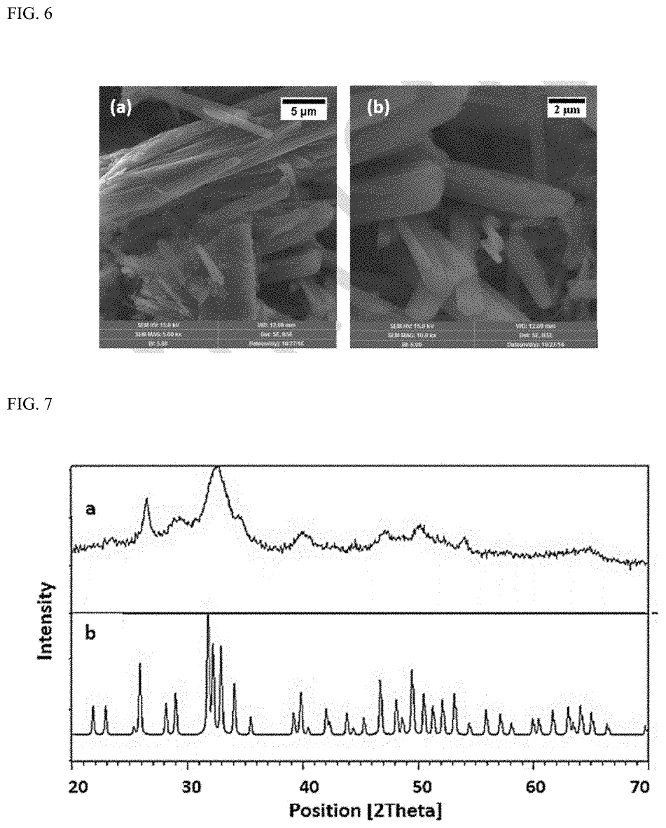

Scanning Electron Microscopy: SEM was performed to analyze morphology and particle size of the samples synthesized in this study. Images (a) and (b) of FIG. 6 show rod like morphology of Zn-HA. Average size of the rods observed was measured to be 10 um (±3) in length×2 um (±0.7) in dia (25 particles measured).

Magnesium Substituted Hydroxyapatite (Mg-HA)

X-ray Diffraction: It is clearly seen from the XRD pattern (a) of FIG. 7 that all peaks match those of HA when compared to ICDD Pattern #09-432. This confirms the phase purity.

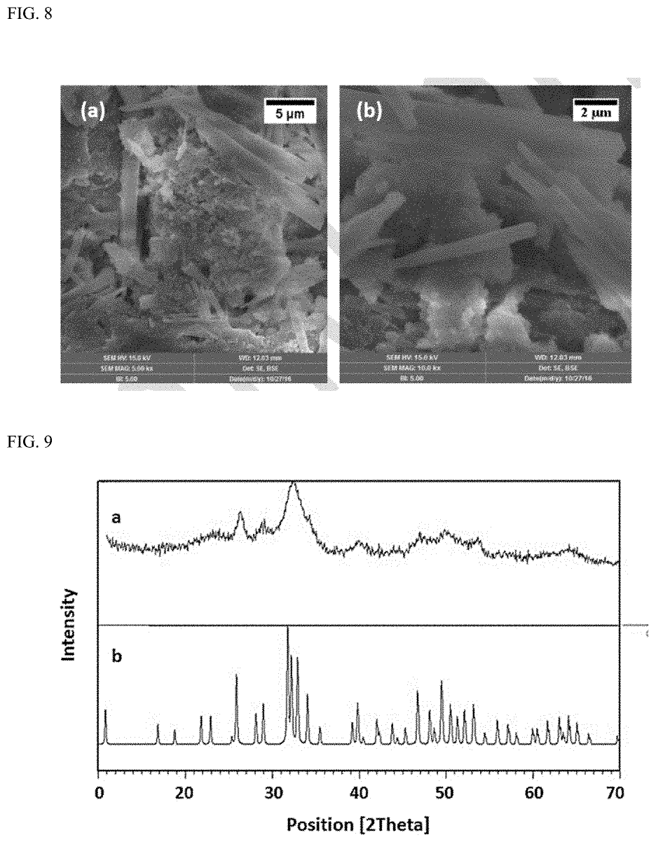

Scanning Electron Microscopy: Scanning Electron Microscopy was performed for morphological analysis of Mg-HA in this study. Images (a) and (b) of FIG. 8 reveal rod like structure of the synthesized samples. Average size of the rods observed was measured to be 15 um (±2) in length x 0.63 um (±0.2) in dia (25 particles measured).

Silicone Substituted Hydroxyapatite (Si-HA)

X-Ray Diffraction: The XRD pattern (a) in FIG. 9 gave a good match to ICDD pattern 09-432, indicating a good match to phase pure hydroxyapatite.

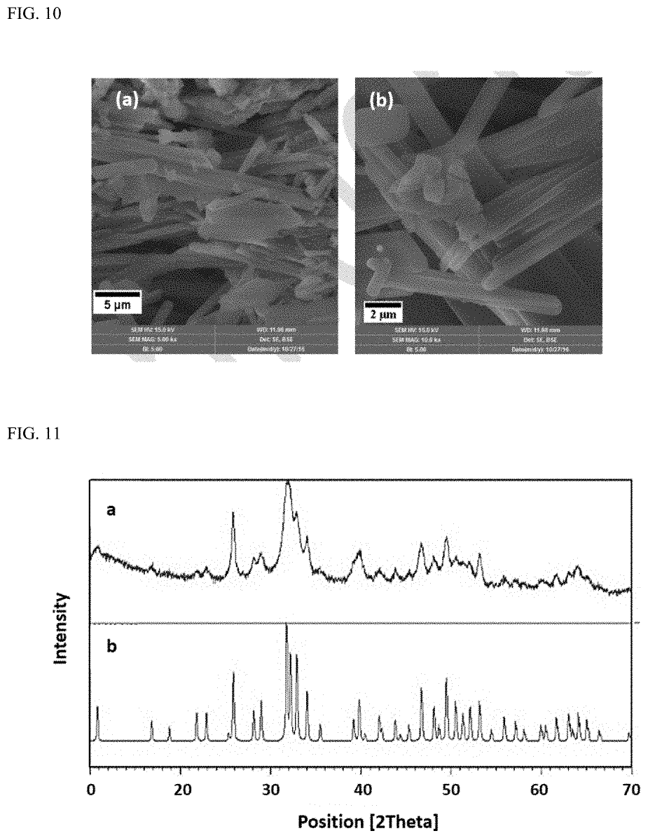

Scanning Electron Microscopy: images (a) and (b) of FIG. 10 show the SEM images of Si-HA. Average size of the rods observed was measured to be 8 um (±2) in length x 0.8 um (±0.3) in dia (25 particles measured).

Carbonate Substituted Hydroxyapatite (CO₃-HA)

X-Ray Diffraction: The XRD pattern (a) of CO₃-HA (Sample D) in FIG. 11 showed a good match to phase pure HA (ICDD Pattern 09-432).

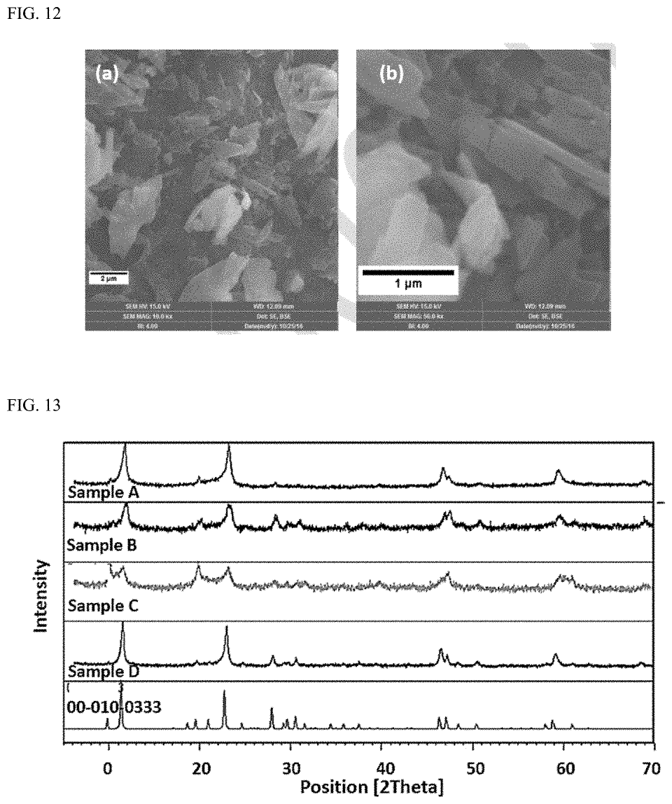

Scanning Electron Microscopy: images (a) and (b) of FIG. 12 show SEM images of CO₃-HA (Sample D) synthesized using the flow synthesis system. The samples revealed to be irregular shaped particles. Average particle size was observed to be 0.7 μm (25 particles measured).

Synthesis of Zinc Phosphates

For the synthesis of zinc phosphates, stock solutions of 0.15M zinc nitrate and 0.1M di ammonium hydrogen phosphase were prepared in deionized water respectively. For first reaction (Sample A), 250 ml each solution was used and pumped at a flow rate of 30 ml/min. In this reaction no pH was adjusted and no heating was involved.

In a second reaction (Sample B) 250 ml of each solution were pumped at same flow rate but pH was adjusted by adding 3 ml of ammonia solution in the original reagent solutions. The third reaction (Sample C) was again done at same flow rate but no pH adjusted but heating was involved up to 70° C. In the fourth reaction (Sample D), again we used 250 ml of each solution but in this reaction no heating and pH adjustment were involved as shown in Table 4. After collection the suspensions were filtered followed by washing with deionized water (×2 times). All the samples were dried in drying oven at 80° C. for 24 hours.

Table: 4 shows the reactions IDs, reaction parameters, concentrations and volumes of precursors used for synthesis of zinc phosphates in this embodiment.

| | | | Volume | | Volume |
|---|---|---|---|---|---|
| Reactions | | Concentration | (mL) | Concentration | (mL) |
| ID | Parameters | Diammonium Hydroxide | | Zinc Nitrate tetra hydrate | |
| Sample A | No Heating, No pH | 0.1M | 250 | 0.15M | 250 |
| Sample B | Heating, pH adjusted | 0.1M | 250 | 0.15M | 250 |
| Sample C | Heating, No pH | 0.1M | 250 | 0.15M | 250 |
| Sample D | No Heating, pH adjusted | 0.1M | 250 | 0.15M | 250 |

X-ray Diffraction: When no heating was used without any pH adjustment Zn₃ (PO₄)₂.2H₂O phase was observed for Sample A in pattern (a) of FIG. 13. Application of heat and pH adjustment led to phase zinc phosphate as seen in pattern (b) FIG. 13. Using heat alone (i.e. without pH adjustment) zinc phosphate tetra hydrate (hopite) was observed in pattern (c) FIG. 13 for Sample C. With pH adjustment alone (i.e. no heating) zinc phosphate hydrate (ICDD Pattern #010-0333) was observed as seen in pattern (d) FIG. 13 for Sample D.

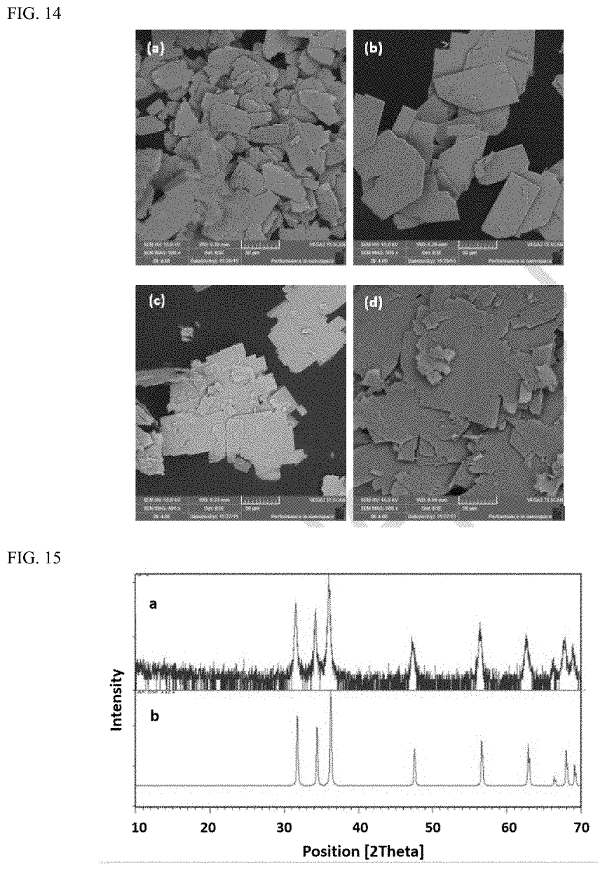

Scanning Electron Microscopy: SEM analysis reveals image (a) of FIG. 14 to have a plate like morphology with an average plate size of 12 μm by 22 μm but when the pH parameter is involved, the size of the platelets become bigger as shown in image (b) of FIG. 14, being 34 μm by 69 μm and when only heating is involved the platelets are aggregated in a peculiar way to form clusters of large platelets as shown in image (c) of FIG. 14. In image (d) of FIG. 14, the platelets fuse into each other with plate size 13 μm by 18 μm due to heating and pH parameters.

Synthesis of Phase Pure and Ion Substituted Oxides

Phase Pure Zinc Oxide

Zinc oxide was synthesized using the 0.3M Zn(NO₃)₂.6H₂O and 0.6M NaOH solutions with a flow rate of 30 ml/min with exit temperature of 70° C. The synthesized samples were then freeze dried for 24 hours to obtain phase pure ZnO.

X-ray Diffraction: pattern (a) of FIG. 15 reveals phase pure ZnO was synthesized when compared to ICDD Pattern #36-1451. No other phases were observed.

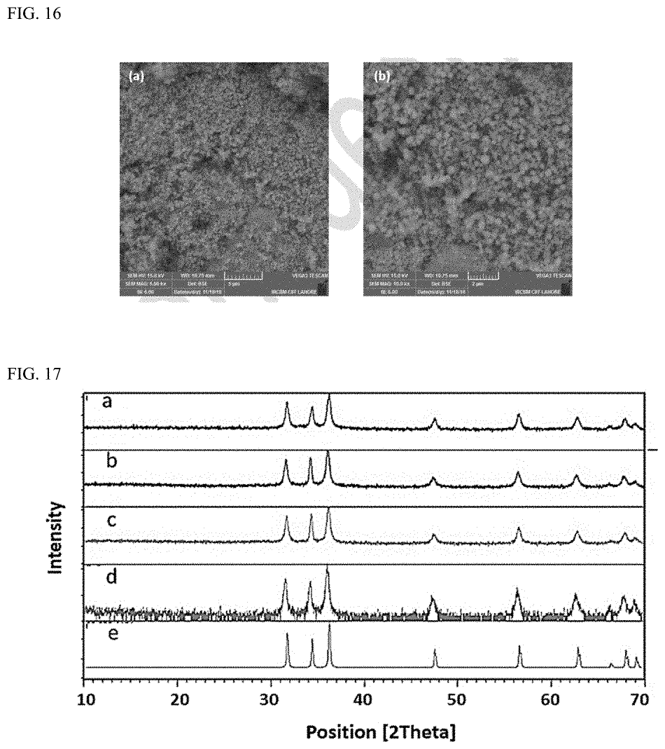

Scanning Electron Microscopy: images (a) and (b) of FIG. 16 reveal particle size ranging from 200-400 nm of spherical shape for phase pure ZnO synthesized using the flow synthesis system.

Ion Doped Zinc Oxides

To synthesize doped-Zinc oxides, pre-weighed dopant sources [Ce(NO₃)₃.6H₂O, KNO₃, Ca(NO₃)₂.4H₂O, Mg(NO₃)₂.6H₂O, & Fe(NO₃)₃.9H₂O] were added to Zinc Nitrate solution.

Cerium, Potassium, Magnesium, Calcium and Iron ions were doped in Zinc Oxide in varying (theoretical) concentrations (0.5 mole %, 1 mole % & 2 mole %). Please see Table 5 for details.

Table: 5 shows the amounts of dopant ion sources added to Zinc Nitrate precursor solution.

| Element | 0.5 mole % | 1 mole % | 2 mole % |
|---|---|---|---|
| Cerium (CeNO₃•6H₂O) | 0.1620 g | 0.3250 g | 0.6510 g |
| Potassium (KNO₃) | 0.0379 g | 0.0700 g | 0.1500 g |
| Calcium (Ca(NO₃)₂•4H₂O) | 0.0886 g | 0.1170 g | 0.3540 g |
| Iron (Fe(NO₃)₃•9H₂O) | 0.1500 g | 0.3000 g | 0.6060 g |
| Magnesium (Mg(NO₃)₂•6H₂O) | 0.0960 g | 0.1900 g | 0.3800 g |

Elemental Analysis (using SEM-EDS): An EDS detector attached to the SEM was used to verify the dopant ions presence in synthesized oxides. The spectra revealed no additional impurities. The results are summarized in Table 6 below. It was observed that the measured dopant amount was generally lesser than the added dopant amount. This difference may be attributed to the high diffusivity of the flow process which provides less (hence quick) residence times. These results elucidate that successful doping was achieved.

TABLE 6
Dopant amounts (mole %) added to precursor solution (theoretical)
and the measured dopants amounts (mole %)

| | Mole % | Average Weight % |
|---|---|---|
| Element | (Theoretical) | (Evaluated) |
| Cerium | 0.50 | 0.45 |
| | 1.00 | 2.10 |
| | 2.00 | 2.64 |
| Potassium | 0.50 | 0.03 |
| | 1.00 | 0.05 |
| | 2.00 | 0.12 |
| Calcium | 0.50 | 0.01 |
| | 1.00 | 0.04 |
| | 2.00 | 0.09 |
| Iron | 0.50 | 0.40 |
| | 1.00 | 0.64 |
| | 2.00 | 1.41 |
| Magnesium | 0.50 | 0.33 |
| | 1.00 | 0.36 |
| | 2.00 | 0.57 |

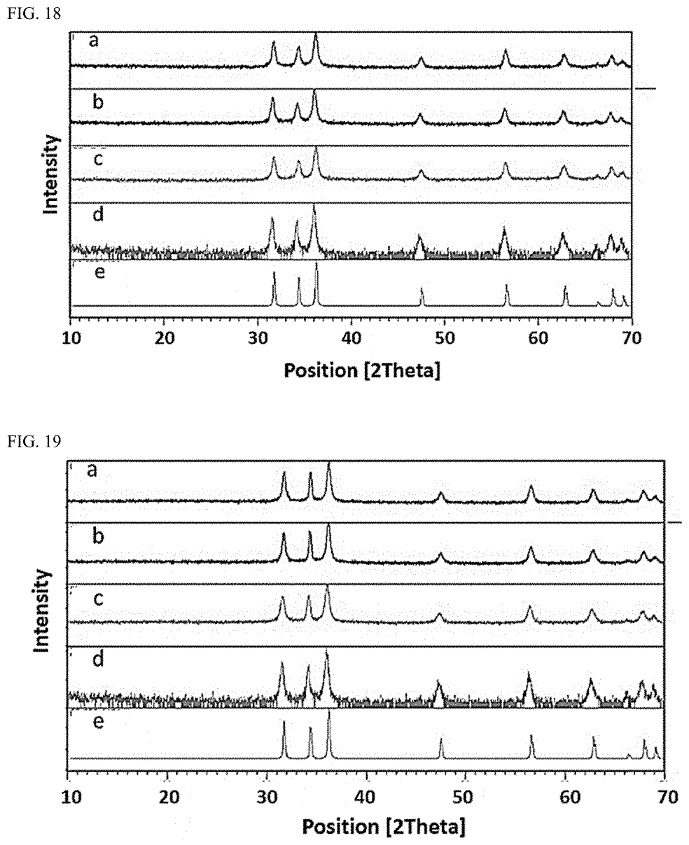

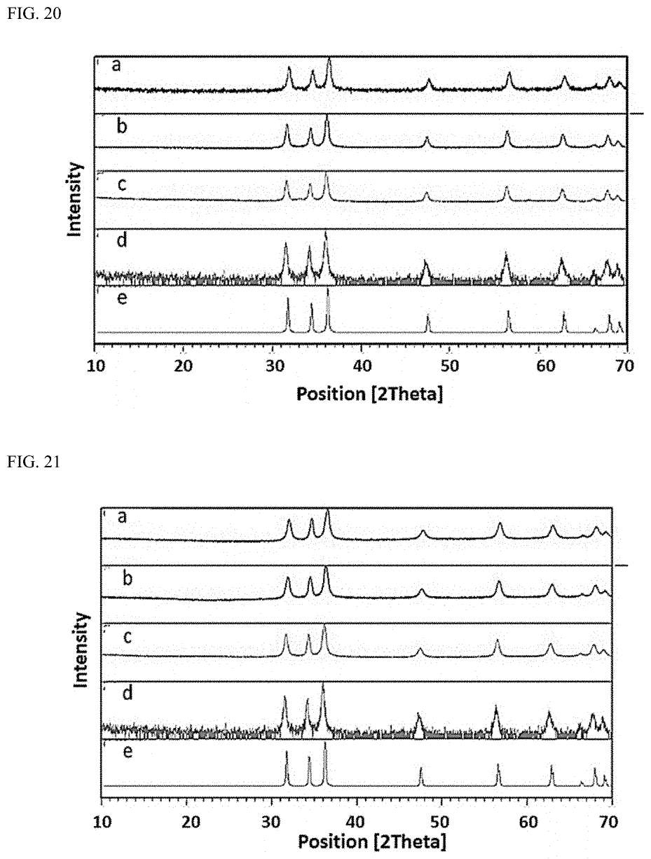

X-Ray Diffraction: patterns (a)-(d) of FIG. 17 show the XRD pattern of cerium doped Zinc Oxides. The XRD patterns gave a good match to ICDD Pattern #36-1451, revealing them to be all Zinc Oxides. With an increase in cerium content from 0.5-2.0 wt % (theoretical) the peaks shifted. This is possibly due to incorporation of the cerium ion in ZnO matrix and resulted effect on lattice. Moreover, peak broadening was noticeable, due to small particle sizes. This may also be due to lesser crystallinity due to low temperature synthesis. Similar trends were observed for Ca, K, Fe and Mg doping, as shown in FIGS. 18-21.

Furthermore, it was observed that the sharpness of the peak reduces along with shift as the dopant concentration increases. It can be inferred that the dopant affects decreases the crystallinity due to ZnO lattice distortion.

Coupled with the confirmation of doping from EDS elemental analysis, the shift in peaks confirms the incorporation of dopant ions in the ZnO lattice. In all the cases, the observed samples were found to be phase-pure (i.e. no other oxides were detected). It is evident that the dopants have broadened the spectra which depicts change in particle size; which were then validated by SEM results.

Scanning Electron Microscopy: Scanning Electron Microscopy was used to investigate the effect of dopant concentrations on particle morphology and aggregation.

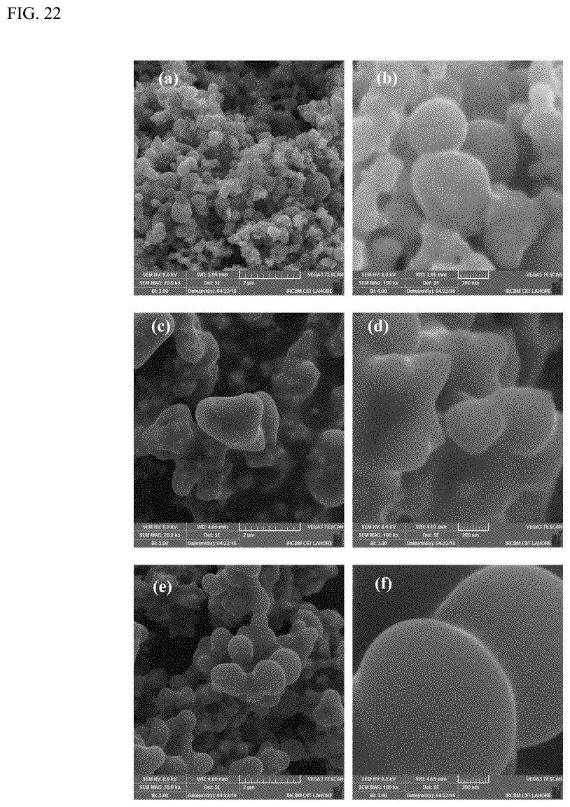

Images (a) and (b) of FIG. 22 show rounded morphology and independent particles of 0.5 mole % (theoretical) CeZnO nanoparticles at 20 k× Magnification. The size of nanoparticles was recorded at 20 k× magnification, the nanoparticles range from 66.1 nm to 271.1 nm and the average size recorded was 177.7558 nm. As the Cerium percent was increased to 1 mole %, the independent particles were reduced and nanoparticles were fused together and average size recorded was 585.0361 nm, as shown in images (c) and (d) of FIG. 22. The size of the particles was also increased with the increase in cerium percentage. Size range recorded was between 53.359 nm to 2523.239 nm, as shown in images (e) and (f) of FIG. 22. Further increase in Cerium percentage, the particles attained more uniform fused morphology (Range: 189 nm to 1509.484 nm) and average size recorded was 610 nm per image (e) of FIG. 22.

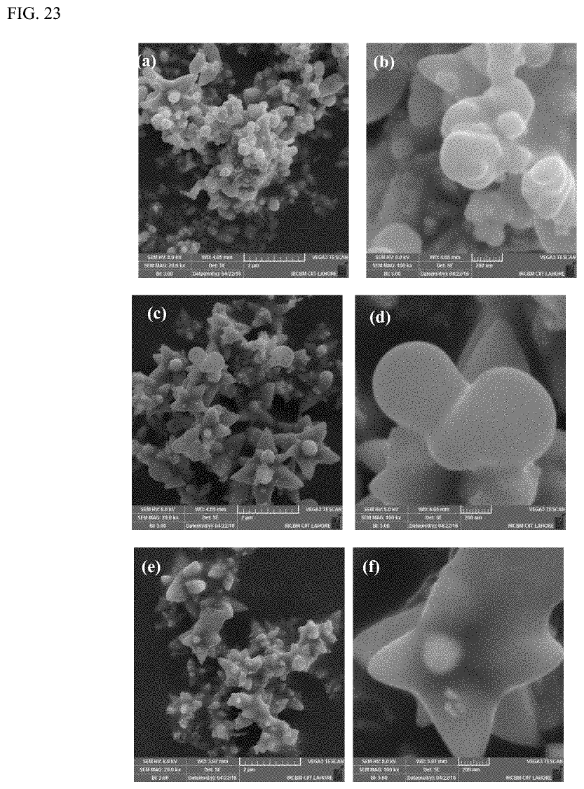

At lower concentration of potassium i.e. 0.5 mole %, the nanoparticles were clustered together and formed agglomerates, the high magnification images (a) and (b) of FIG. 23 verify the particle fusion. The average particle size recorded was 224 nm and depicts the irregular morphology, as shown in images (a) and (b) of FIG. 23. As the potassium concentration was increased to 1 mole %, the morphology became more uniform and particles were arranged in a 4-petal arrangement fused together to form bigger particle (˜447.155 nm) in a regular manner, as shown in images (c) and (d) of FIG. 23. However, at 2 mole % potassium, the morphology became more regular fused four petal arrangements. No independent particles were seen and average size recorded was 550.7154 nm, as shown in images (e) and (f) of FIG. 23.

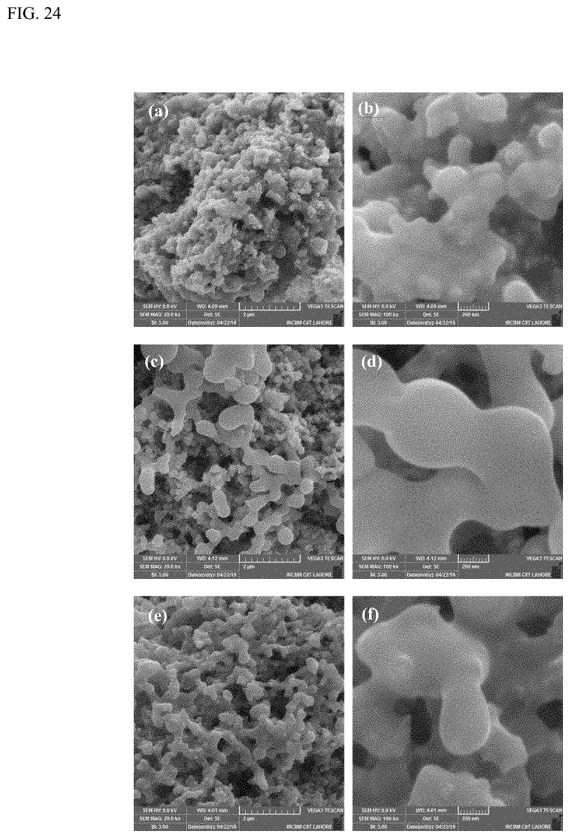

The calcium doping at 0.5 mole % resulted in agglomeration of nanoparticles. The image (a) at low magnification of FIG. 24 demonstrates the irregular arrangement of particles which are fused together. The average size recorded was 112 nm, as shown in images (a) and (b) of FIG. 24. With increase in Calcium percentage (1 mole %) the morphology attained a certain pattern which was uniform than the previous one and particles size was increased as well, as shown in image (c) of FIG. 24. With further increase, the pattern became more regular, the independent particles were reduced to almost zero. Image (f) of FIG. 24 shows the fusion of globules in a specific manner hence attaining a regular pattern, as shown in image (e) of FIG. 24.

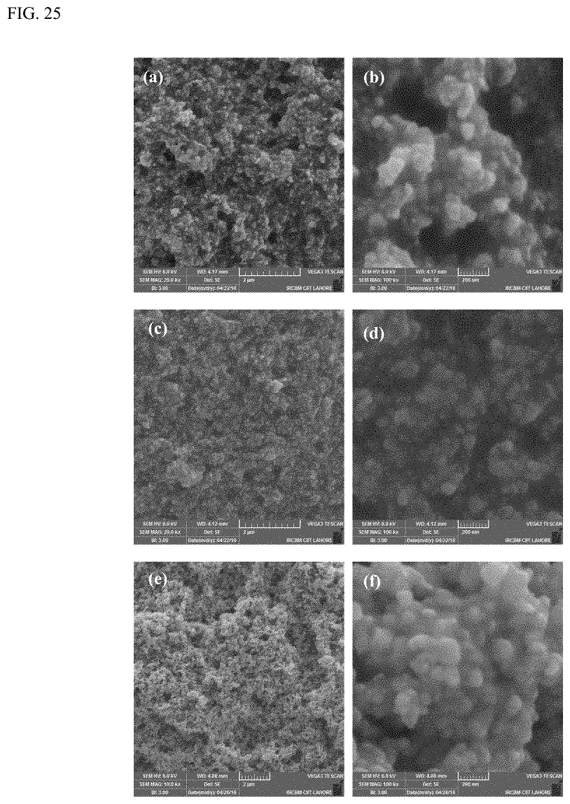

0.5 mole % Fe doped ZnO depicted very small independent features of about 33.194 nm to 126.399 nm at low magnification. However, at high magnification the fused entities were spotted (˜72.05812 nm), as shown in images (a) and (b) of FIG. 25. As the Fe percentage was increased the features became larger. In fact, a combination was large and small features were seen agglomerated together, as shown in images (c) and (d) of FIG. 25. At further increase the particles became larger and globular, but highly fused together, as shown in images (e) and (f) of FIG. 25.

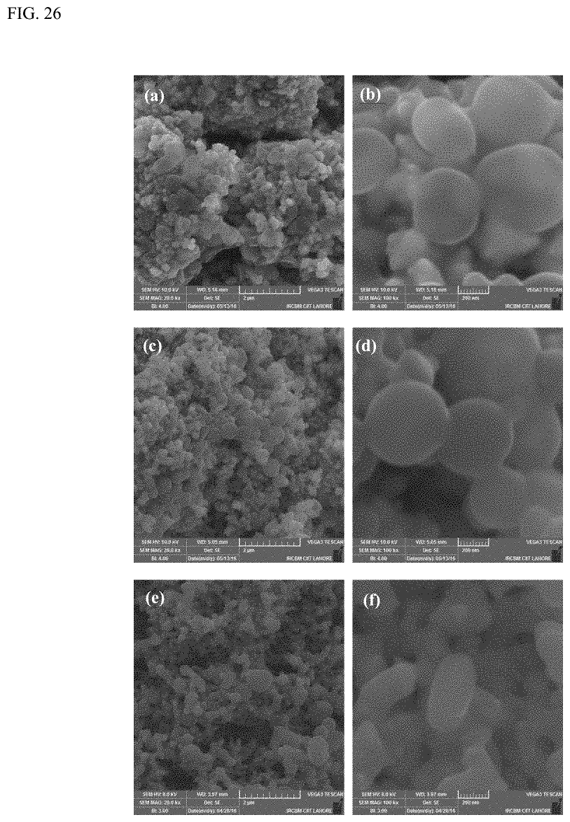

Similarly, the doping of Mg to ZnO lead to particle growth when the dopant concentration was increased to 2%, as shown in images (e) and (f) of FIG. 26. At 0.5% Mg concentration, the particles' size was smaller and rounded structure which was independent, as shown in images (a) and (b) of FIG. 26. However, with the increase in dopant amount the size was increased along with particle fusion, as shown in images (c) and (d) of FIG. 26.

Phase Pure Cerium Oxide Synthesis

Cerium oxide was synthesized using the reagents cerium nitrate tetra hydrate (0.1M in 250 ml water) and sodium hydroxide (1M in 250 ml water) at a flow rate of 30 ml/min. The synthesized sample was freeze dried at 4000 rpm followed by twice washing.

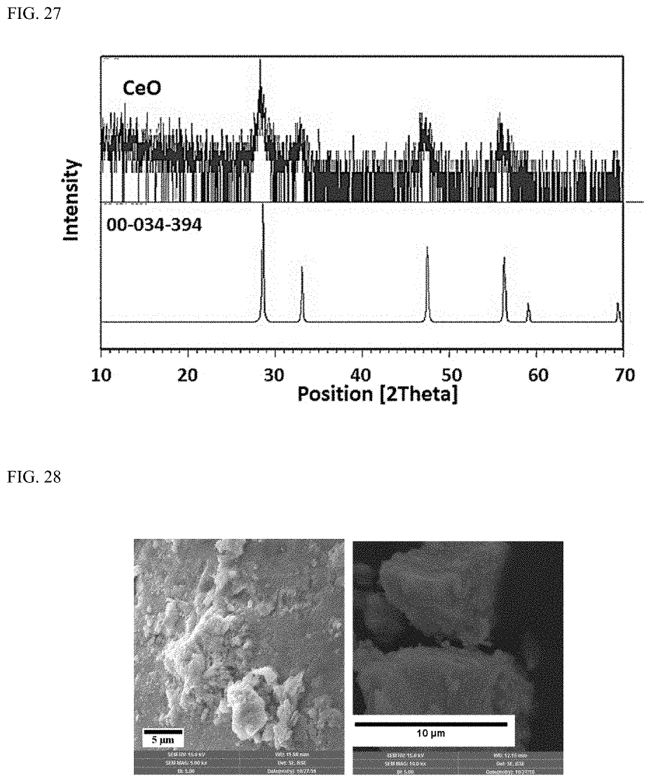

X-Ray Diffraction: XRD pattern shown in FIG. 27 corresponds to phase pure CeO₂ as compared to ICDD pattern #34-0394. No secondary phase was observed in the synthesized sample.

Scanning Electron Microscopy: Scanning Electron Microscopy of CeO₂ was performed to analyze particle size and morphology. FIG. 28(a)-(b) shows particle size ranging from 2 μm-10 μm (25 particles measured).

Grafted Oxides

Surface modification using the flow synthesis system was carried out. A monomer urethane dimethacrylate (UDMA) was grafted onto ZnO particles by utilizing a third stream in the pumps.

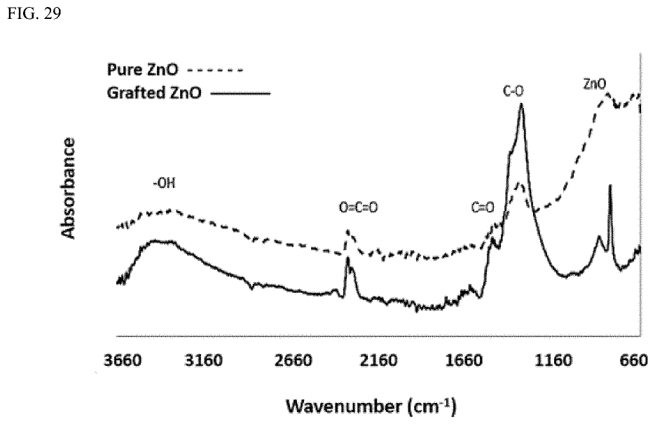

FIG. 29 shows the FTIR image of phase pure and grafted ZnO. The broad band at 3350-3500 cm⁻¹ is due to stretching vibrations of OH group on surface of ZnO particles seen in both FTIR spectra. The sharp peak at 1550 cm⁻¹ in FTIR spectrum for grafted ZnO is attributed to C—O, the second amide peak. This peak is absent in the non-grafted ZnO. This proves that UDMA was successfully grafted onto ZnO. The sharp peak at 1350 cm⁻¹ is carbonate peak which changes after grafting of polymer. The peak observed at 830 cm⁻¹ is due to zinc.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

1. A system comprising:
a pump with three feeds;
a stainless steel T-piece reactor; and
a heater having tubing passing through it,
wherein:
the pump is connected to the T-piece reactor,
the T-piece reactor is connected to the tubing passing through the heater, and
the feeds and the tubing are formed of contamination free polytetrafluoroethylene (PTFE).

2. The system of claim 1, wherein a first feed of the pump sends a first solution to the T-piece reactor and a second feed of the pump sends a second solution to the T-piece reactor.

3. The system of claim 2, wherein the third feed of the pump sends a third solution to the T-piece reactor.

4. A method to synthesize at least one of inorganic particles and inorganic nanoparticles, comprising:
providing a system comprising:
a peristaltic pump with three feeds configured for 30 ml/min flow rates;
a stainless steel T-piece or X-piece reactor; and
a heater having tubing passing through it,
wherein:
the pump is connected to the T-piece or X-piece reactor,
the T-piece or X-piece reactor is connected to the tubing passing through the heater, and
the feeds and the tubing are formed of contamination free polytetrafluoroethylene (PTFE);
sending a first solution with a first feed of the pump at a flow rate of 30 ml/min to the T-piece or X-piece reactor;
sending a second solution with a second feed of the pump at a flow rate of 30 ml/min to the T-piece or X-piece reactor; and
reacting the solutions in the T-piece or X-piece reactor to form a reaction suspension.

5. The method of claim 4, further comprising passing the reaction suspension of the T-piece or X-piece reactor passes through the heater.

6. The method of claim 5, further comprising discharging the suspension from the heater and is collected collecting the suspension in a container in a continuous manner.

7. The method of claim 4, further comprising selecting the first solution and second solution for continuous flow synthesis of grafted and non-grafted inorganic nanoparticles.

8. The method of claim 4, further comprising selecting the first solution and second solution for the synthesis of inorganic particles and nanoparticles.

9. The method of claim 4, further comprising selecting the first solution and second solution for the synthesis of inorganic particles and nanoparticles of a single phase.

10. The method of claim 4, further comprising selecting the first solution and second solution for the synthesis of inorganic particles and nanoparticles belonging to different phases.

11. The method of claim 4, further comprising selecting the first solution and second solution for the synthesis of inorganic particles and nanoparticles grafted with organic groups.

12. The method of claim 4, further comprising selecting the first solution and second solution for synthesis based on variable flow rates.

13. The method of claim 4, further comprising maintaining a same flow rate in all feeds.

14. (canceled)

15. The method of claim 4, further comprising increasing reaction times by increasing a length of the tubing in the heater.

16. The method of claim 4, further comprising using different solution concentrations to influence reaction yield.

17. The method of claim 4, further comprising varying a pH of the feed solutions.

18. The method of claim 4, further comprising independently varying a pH of all feed solutions.

19. The method of claim 4, further comprising synthesizing inorganic particles with varying crystallinity.

20. The method of claim 4, further comprising varying reaction temperatures.

21. The method of claim 4, further comprising varying reaction temperatures to influence phase purity of product.

22. The method of claim 4, further comprising varying reaction temperatures to influence crystallinity.

23. The method of claim 4, further comprising synthesizing grafted and non-grafted inorganic particles and nanoparticles in gram or kilogram level yields.

24. The method of claim 4, further comprising doping different elements into inorganic particles and nanoparticles.

25. The method of claim 4, further comprising varying resultant particle size is varied.

26. The method of claim 4, further comprising varying dopant levels into inorganic particles and nanoparticles.

27. The method of claim 4, further comprising carrying out reactions based on a water soluble reagent.

28. The method of claim 4, further comprising providing the feeds in the form of suspensions.
